(19) United States
(12) Patent Application Publication
(10) Pub. No.: US 2010/0049947 A1
(43) Pub. Date: Feb. 25, 2010

(54) PROCESSOR AND EARLY-LOAD METHOD THEREOF

(75) Inventors: Shun-Chieh Chang, Taichung County (TW); Yuan-Hwa Li, Taipei City (TW); Yuan-Jung Kuo, Taipei County (TW); Chin-Ling Huang, Taipei City (TW); Chung-Ping Chung, Hsinchu City (TW)

Correspondence Address: J C PATENTS, 4 VENTURE, SUITE 250, IRVINE, CA, 92618, US

(73) Assignee: FARADAY TECHNOLOGY CORP., Hsinchu (TW)

(21) Appl. No.: 12/196,838

(22) Filed: Aug. 22, 2008

(51) Int. Cl. G06F 9/38

(52) U.S. Cl. 712/207; 712/E09.055

(57) ABSTRACT

A processor and an early-load method thereof are provided. In the early-load method, an instruction is fetched and determined in an instruction fetch stage to obtain a determination result. Whether to early-load an early-loaded data corresponding to the instruction is determined according to the determination result. A target data is fetched according to the instruction in an instruction execution stage if the early-loaded data is not loaded correctly. The early-loaded data is served as the target data if the early-loaded data is loaded correctly.

### BACKGROUND OF THE INVENTION

1. Field of the Invention

The present invention generally relates to a processor, and more particularly, to a pipeline processor.

2. Description of Related Art

FIG. 1 illustrates a conventional pipeline processor. Referring to FIG. 1, only a pipeline 100 of the conventional pipeline processor is illustrated. The pipeline 100 has an instruction fetch stage 110, an instruction queue 120, an instruction decode stage 130, an instruction execution stage 140, and a data write-back stage 150. In the conventional processor design, the instruction fetch stage 110 and the instruction decode stage 130 is separated by the instruction queue 120 so as to reduce the performance loss of the processor caused by unstable issue rate and fetch rate. Accordingly, most instructions do not enter the instruction decode stage 130 right after they are fetched into the processor; instead, they wait in the instruction queue 120 for a while. The instruction fetch stage 110 fetches instructions from an instruction cache memory (or a main memory) and sends the instructions into the instruction queue 120. The instruction queue 120 stores the instructions fetched by the instruction fetch stage 110 based on the first in first out (FIFO) rule and provides the instructions to the instruction decode stage 130 sequentially.

Generally speaking, before executing an instruction, the processor needs to decode the “instruction code” by using the instruction decode stage 130. The decoded instruction is sent to the instruction execution stage 140. The instruction execution stage 140 includes an arithmetic and logic unit (ALU) which executes an instruction operation according to the decoding result of the instruction decode stage 130. If the instruction operation executed by the instruction execution stage 140 generates a calculation result, the data write-back stage 150 then writes the calculation result back into the register file or cache memory (or main memory).

In the conventional processor design, the delay between data loading and data processing increases along with the depth of the pipeline, and which may affect the performance of the processor considerably. For example, referring to the following instruction string:

| | |
|---|---|
| LOAD | Rm, [mem_addr] |
| ADD | Rd, Rn, Rm, |

the instruction fetch stage 110 fetches foregoing LOAD instruction and ADD instruction sequentially from the memory and stores them into the instruction queue 120. After the instruction decode stage 130 decodes these instructions, the instruction execution stage 140 first executes the LOAD instruction. Namely, a load/store unit (not shown) in the instruction execution stage 140 fetches data from an address mem_addr in the cache memory (or main memory) and stores the data into a register Rm. This data reading operation is completed in the instruction execution stage 140. If the instruction execution stage 140 needs n clocks to finish the LOAD instruction, then the next instruction (i.e., the ADD instruction) has to wait for n clocks until the data is ready in the register Rm. The operation of conventional pipeline processor is simply described above with a four-level pipeline 100; however, the delay between data loading and data processing will increase along with the depth (level) of the pipeline.

### SUMMARY OF THE INVENTION

Accordingly, the present invention is directed to a pre-load method of a processor. According to this method, an instruction is fetched and determined in an instruction fetch stage to obtain a determination result. Whether to early-load an early-loaded data corresponding to the instruction is determined according to the determination result. The early-loaded data is served as a target data if the early-loaded data is loaded correctly.

According to an embodiment of the present invention, the target data is fetched according to the instruction in an instruction execution stage if the early-loaded data is not loaded correctly.

The present invention provides a processor including an instruction fetch stage, an instruction decode stage, an instruction execution stage, and an early-load queue (ELQ). The instruction fetch stage fetches an instruction, wherein the instruction fetch stage includes a pre-decoding unit for pre-determining the instruction in the instruction fetch stage to obtain a determination result. The instruction decode stage coupled to the instruction fetch stage decodes the instruction to obtain a decoding result. The instruction execution stage coupled to the instruction decode stage executes the instruction according to the decoding result. The ELQ coupled to the pre-decoding unit determines whether to early-load an early-loaded data corresponding to the instruction according to the determination result. The instruction execution stage fetches a target data according to the instruction if the early-loaded data is not loaded correctly, and the early-loaded data is served as the target data if the early-loaded data is correctly loaded into the ELQ.

According to an embodiment of the present invention, the early-loaded data corresponding to the instruction is loaded into the ELQ if the determination result shows that the instruction belongs to a target type and the state of a register corresponding to the instruction in a register status table is ready.

According to an embodiment of the present invention, whether the data in the ELQ is ready and valid is checked in the instruction decode stage. If the data in the ELQ is ready and valid, the address of a destination register appointed by the instruction is changed to the address of the early-loaded data in the ELQ.

In the present invention, an early-loaded data corresponding to an instruction is early-loaded when the instruction waits in an instruction queue. Thereby, the problem of delay between data loading and data processing in the design of deep pipeline processor is resolved. The present invention can be implemented along with any design of pipeline processor, e.g. 4-stage pipeline processor, 12-stage ARM ISA pipeline processor, or other type pipeline processor.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a conventional pipeline processor.

FIG. 2 is a flowchart of an early-load method of a processor according to an embodiment of the present invention.

FIG. 3A is a flowchart of an early-load method of a processor according to another embodiment of the present invention.

FIG. 3B illustrates a pipeline processor according to an embodiment of the present invention.

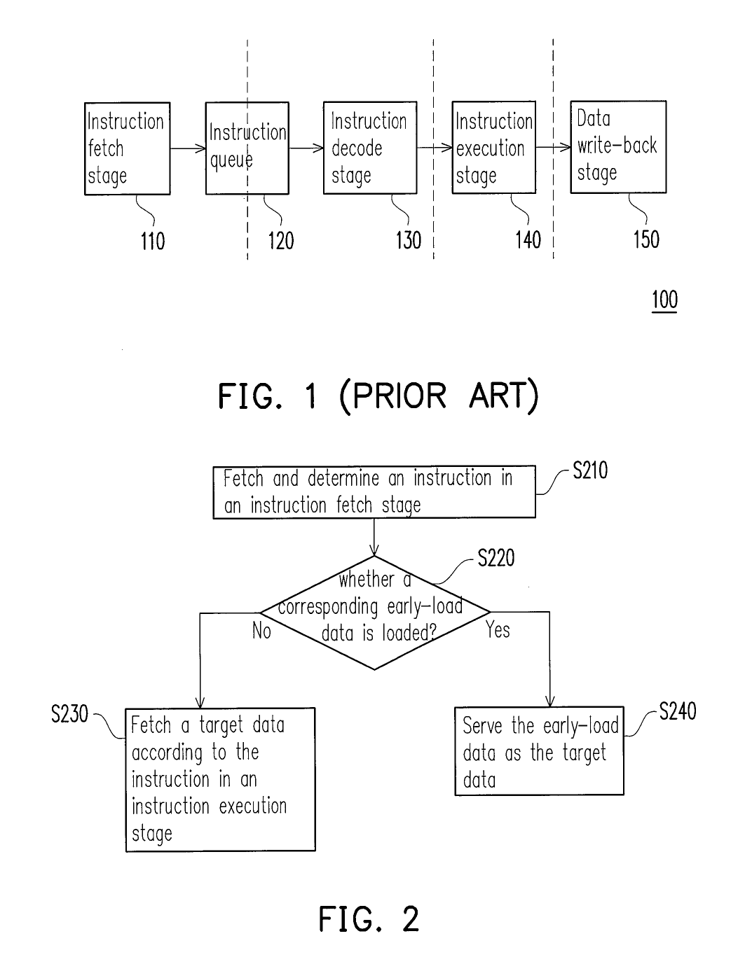

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

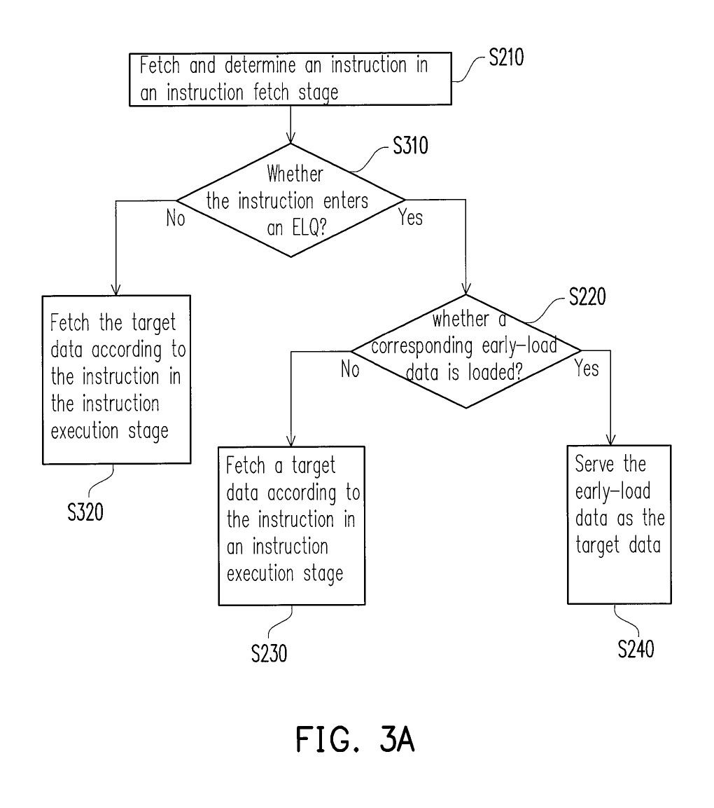

FIG. 2 is a flowchart of an early-load method of a processor according to an embodiment of the present invention. When the instruction fetch stage fetches an instruction, the instruction fetch stage first determines the instruction to obtain a determination result (step S210). The processor determines whether to early-load an early-loaded data corresponding to the instruction according to the determination result (step S220). If the early-loaded data is not correctly loaded, the instruction execution stage fetches a target data according to the instruction (step S230). If the early-loaded data is correctly loaded, the processor serves the early-loaded data as the target data (step S240).

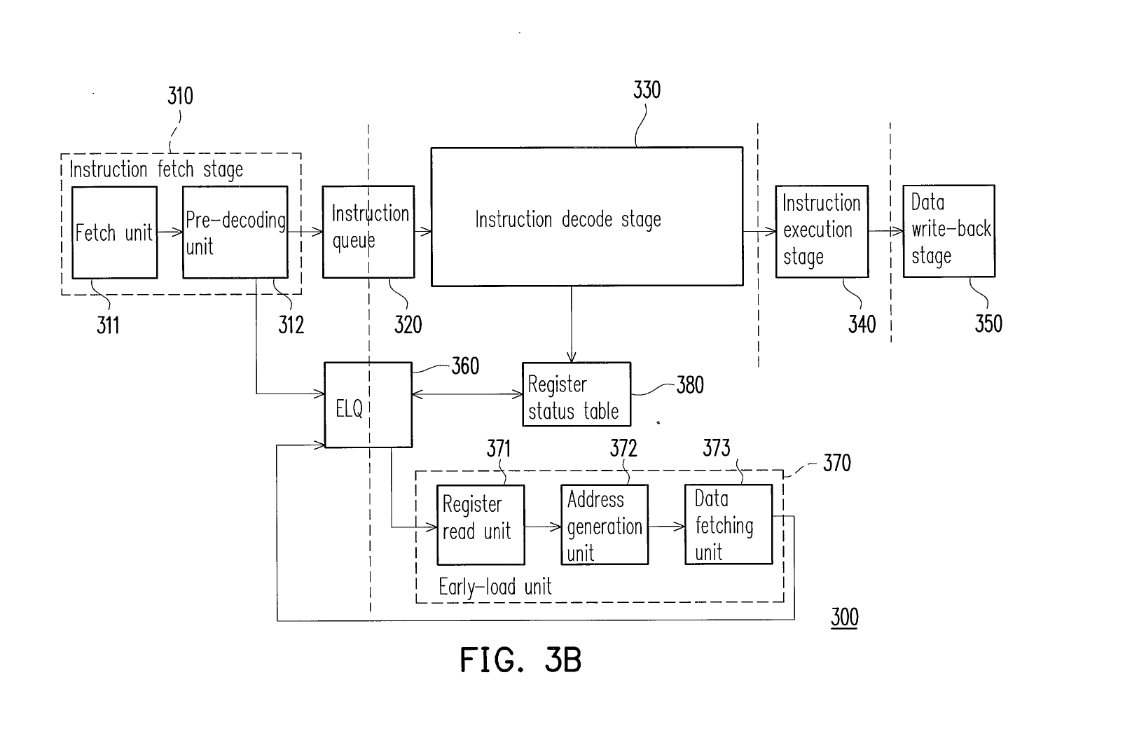

The embodiment described above can be revised according to the actual requirement by those having ordinary knowledge in the art. FIG. 3A is a flowchart of an early-load method of a processor according to another embodiment of the present invention. Compared to the embodiment described above, a determination step is further executed between steps S210 and S220 in the present embodiment (step S310). Referring to FIG. 3A, in step S210, the instruction fetch stage fetches an instruction from an instruction memory (or an instruction cache) and pre-determines (or pre-decodes) the instruction. Thus, before the instruction enters an instruction queue, whether the instruction needs to fetch data from a data cache (or a data memory) can be determined in advance in step S210.

In step S310, whether to store the instruction into an early-load queue (ELQ) is determined according to the determination result obtained in step S210. If the instruction does not belong to a target type (for example, needs not to fetch data from the data cache), the instruction is stored only into the instruction queue (the instruction is not stored into the ELQ). Then, the instruction is executed by an instruction decode stage and an instruction execution stage (step S320). However, if the instruction does not belong to the target type but still needs to fetch data from the data cache, in step S320, the instruction execution stage fetches the data from the data cache according to the instruction.

In step S310, whether to place the instruction into the ELQ and the instruction queue may also be determined according to the determination result. If the instruction is placed into the ELQ in step S310, then in step S220, whether a register appointed by the instruction is in a ready state is checked in the register status table, and the early-loaded data corresponding to the instruction is loaded from the data cache into the ELQ. Thus, the instruction can be executed in the ELQ to load the corresponding early-loaded data and then place the early-loaded data into the ELQ before the instruction execution stage (when the instruction still waits to be executed in the instruction queue). After that, the instruction stored in the instruction queue is sent to the instruction decode stage. In the present embodiment, the processor decodes the instruction in the instruction decode stage to obtain a decoding result. The processor checks the register status table to determine whether the early-loaded data is correctly loaded into the ELQ according to the decoding result. If the early-loaded data is not correctly loaded, the instruction execution stage fetches a target data from the data cache according to the instruction (step S230). If the early-loaded data is correctly loaded, the processor serves the early-loaded data as the target data (step S240) so that the instruction execution stage needs not to spend time to fetch the target data from the data cache.

An invalidation mechanism can be disposed in the embodiment described above according to the actual requirement by those having ordinary knowledge in the art so as to prevent foregoing early-load operation from accessing incorrect data. For example, if a second instruction (any instruction) is decoded in the instruction decode stage, the state of a destination register appointed by the second instruction in the register status table is set to busy so that other instructions will not access the same register. After that, all the entries in the ELQ are searched. If an entry in the ELQ points to the destination register appointed by the second instruction, the entry is set to invalid. Accordingly, the problem of data dependence is avoided.

Moreover, if a second instruction (any instruction) writes data into a particular memory address in the instruction execution stage, the ELQ is searched. If an entry in the ELQ is the same as the memory address appointed by the second instruction, the entry is set to invalid. Accordingly, the problem of the memory dependency is avoided.

In another embodiment of the present invention disposed with the invalidation mechanism, foregoing step S240 may further include following steps. Whether data in the ELQ is ready and valid is checked in the instruction decode stage. If the data in the ELQ is ready and valid, the address of the destination register appointed by the instruction is changed to the address of the early-loaded data in the ELQ.

The embodiment described above can be implemented along with any design of pipeline processor by those having ordinary knowledge in the art. For example, the embodiment described above can be implemented along with 12-stage ARM ISA pipeline processor or other type pipeline processor. FIG. 3B illustrates a 4-stage pipeline processor according to an embodiment of the present invention. Only a pipeline 300 of the pipeline processor is illustrated in FIG. 3B. The pipeline 300 has an instruction fetch stage 310, an instruction queue 320, an instruction decode stage 330, an instruction execution stage 340, and a data write-back stage 350. The instruction queue 320 is disposed between the instruction fetch stage 310 and the instruction decode stage 330 so as to reduce the performance loss of the processor caused by unstable issue rate and fetch rate. The instruction fetch stage 310 fetches an instruction from an instruction cache memory (or a main memory). After being fetched into the processor, the instruction waits for some time in the instruction queue 320 before it enters the instruction decode stage 330. The instruction queue 320 stores instructions fetched by the instruction fetch stage 310 based on the first in first out (FIFO) rule and provides the instructions to the instruction decode stage 330 sequentially.

Before the instruction is executed, the “instruction code” is decoded by using the instruction decode stage 330 to obtain a decoding result. The decoded instruction is sent to the instruction execution stage 340. The decoded instruction is then executed by the instruction execution stage 340. If the instruction is a LOAD instruction (for example, an instruction type for loading data into a register, such as LDR and LDRB), a loading/storage unit (not shown) in the instruction execution stage 340 fetches data from a data cache memory (or main memory) and stores the data into a register array (not shown) in the processor. The instruction execution stage 340 further includes an arithmetic and logic unit (ALU) which executes an instruction operation according to the decoding result of the instruction decode stage 330. If the instruction operation executed by the instruction execution stage 340 generates a calculation result, the data write-back stage 350 writes the calculation result back into the data cache memory (or main memory).

In the present embodiment, the instruction fetch stage 310 includes a fetch unit 311 and a pre-decoding unit 312. The fetch unit 311 fetches an instruction from the instruction cache memory (or main memory). The pre-decoding unit 312 determines the instruction fetched by the fetch unit 311 to obtain a determination result.

The pipeline 300 further has an ELQ 360. To the instruction stream, the ELQ 360 may be a small table parallel to the instruction queue 320. The ELQ 360 is coupled to the pre-decoding unit 312. The pre-decoding unit 312 determines whether to write the instruction into the ELQ 360 according to the determination result. In another embodiment of the present invention, the ELQ 360 determines whether to record the instruction according to the determination result. In the present embodiment, if the determination result shows that the instruction fetched by the fetch unit 311 belongs to a target type (for example, an instruction type for loading data into a register, such as LDR and LDRB), the pre-decoding unit 312 writes the instruction into both the instruction queue 320 and the ELQ 360. Otherwise, if the determination result shows that the instruction fetched by the fetch unit 311 does not belong to the target type, the pre-decoding unit 312 writes the instruction into the instruction queue 320 but not the ELQ 360.

The processor determines whether to fetch the early-loaded data corresponding to the instruction into the ELQ 360 in advance according to the determination result of the pre-decoding unit 312. If the early-loaded data is not correctly fetched into the ELQ 360, the instruction execution stage 340 fetches data according to the instruction (referred as target data herein). If the early-loaded data is correctly fetched into the ELQ 360, the processor serves the early-loaded data in the ELQ 360 as the target data. Taking a LDR instruction as an example, the processor can fetch data (referred as early-loaded data herein) from an address appointed by the LDR instruction into the ELQ 360 when the instruction is still in the instruction queue 320. Thus, when the LDR instruction enters the instruction execution stage 340, the instruction execution stage 340 can use the early-loaded data in the ELQ 360 instead of fetching the target data from the data cache memory (or main memory).

The operation described above for early-loaded data can be implemented by different means. For example, in the embodiment illustrated in FIG. 3B, the operation for early-loaded data is completed by using an early-load unit 370. The ELQ 360 keeps the instruction provided by the fetch unit 311 and requests the early-load unit 370 to fetch the target data. The ELQ 360 can be implemented by referring to the data structure shown in table 1. In table 1, the state field State[1:0] records the state of each entry/instruction in the ELQ 360. For example, “00” represents “invalid”, “01” represents “busy”, “10” represents “ready”, and “11” represents “using”. The program counter field PC[1:0] records the program counter of the entry/instruction (i.e., the address of the instruction). The register information fields Base_ID[3:0] and Offset[11:0] record the address (base and offset) of a destination register to which the instruction stores data. The field Adr_mode[1:0] records the addressing mode of the instruction, such as pre-index mode, post-index mode, and auto-index mode. The memory address field Adr[31:0] records the memory address of the data to be loaded by the instruction. The early-loaded data field Loaded_data[31:0] records the early-loaded data fetched by the instruction through the early-load unit 370.

The pre-decoding unit 312 in the instruction fetch stage 310 can identify the type of the instruction and decode the base register index, offset, and addressing mode of the instruction. If the instruction has an address format of “reg+immediate”, the instruction is placed into the ELQ 360 and the state thereof is set to “ready” in the ELQ 360.

TABLE 1
Data structure of ELQ 360

| State | PC | Base_ID | Offset | Adr_mode | Adr | Loaded_data |
|---|---|---|---|---|---|---|
| [1:0] | [31:0] | [3:0] | [11:0] | [1:0] | [31:0] | [31:0] |

The early-load unit 370 is coupled to the ELQ 360. When the early-load unit 370 is idle, the ELQ 360 selects the earliest instruction stored therein and sends the instruction to the early-load unit 370 to be executed. Thus, before the instruction (for example, a LDR instruction) enters the instruction execution stage 340 (when it is still in the instruction queue 320), the early-load unit 370 executes the instruction in advance and places the early-loaded data corresponding to the instruction into the early-loaded data field Loaded_data of the ELQ 360.

In FIG. 3B, the early-load unit 370 is illustrated as an exclusive circuit in the processor, and the detailed implementation thereof will be described below with an example. However, this example is only to describe the implementation of the early-load unit 370 in an intuitional way but not for limiting the implementation scope thereof. For example, the function of the early-load unit 370 can be accomplished by using a loading/storage unit (not shown) in the conventional instruction execution stage 340, namely, the early-load unit 370 and the loading/storage unit in the instruction execution stage 340 share their hardware. In the present embodiment, the early-load unit 370 includes a register read unit 371, an address generation unit 372, and a data fetching unit 373. The register read unit 371 checks whether there is an instruction which needs to early-loaded data in the ELQ 360, then reads a base register data from a register array (not shown) in the processor, and sends the instruction to the address generation unit 372. The address generation unit 372 generates an address for fetching the data according to the instruction and the base register data. The data fetching unit 373 loads the data from the data cache memory (or main memory) in advance according to the address generated by the address generation unit 372 and writes the early-loaded data back into the ELQ 360.

The instruction decode stage 330 checks whether the data in the ELQ 360 is ready and valid. When the instruction is sent from the instruction queue 320 to the instruction decode stage 330, the instruction decode stage 330 checks the entry state in the ELQ 360. If the data in the ELQ 360 is ready and valid, the address of a destination register appointed by the instruction is changed to the address of the early-loaded data in the ELQ 360. As a result, the instruction needs not to fetch the data from the data cache any more; namely, the instruction execution stage 340 needs not to execute the instruction again. Thus, those instructions corresponding to the same destination register can obtain their data from the ELQ 360. The operation described above for checking the ELQ 360 can be implemented by different means.

In the present embodiment, a register status table 380 coupled to the instruction decode stage 330 is further disposed for recording the states of all the registers in the processor. If the determination result of the instruction fetch stage 310 shows that the instruction belongs to a target type (for example, a LDR instruction or a LDRB instruction) and the register status table 380 shows that the register appointed by the instruction is in the ready state, the early-loaded data to be fetched by the instruction is early-loaded into the ELQ 360. The register status table 380 can be implemented by referring to the data structure shown in table 2. In table 2, the register field records the address of each register in the processor. The state field State[1:0] records the state information of each register. For example, “00” represents “ready”, “01” represents “forwarding”, “10” represents “renaming”, and “11” represents “busy”. The ELQ address field ELQ_ID[2:0] records the address that the register is renamed to in the ELQ 360.

TABLE 2
Data structure of register status table 380

Register

| | R0 | R1 | R2 | R3 | R4 | . . . |
|---|---|---|---|---|---|---|
| State[1:0] | | | | | | |
| ELQ_ID[2:0] | | | | | | |

The instruction decode stage 330 decodes the instruction and checks the register status table 380 according to the decoding result to determine whether the early-loaded data required by the instruction is correctly loaded into the ELQ 360. Finally, the instruction decode stage 330 sends the decoded instruction to the instruction execution stage 340 according to aforementioned checking and processing results.

Table 3 is a process timing table of each instruction in a pipeline when the processor executes a particular program segment by using the early-load method described above. Table 4 is a process timing table of each instruction in the pipeline when the processor executes the same program segment without using the early-load method. In the tables, IF represents “instruction fetching”, ID represents “instruction decoding”, EXE represents “executing instruction”, MEM represents “fetching data”, and WB represents “data write-back”. In addition, EL represents that the early-load method is executed.

TABLE 3
Process timing table of each instruction in the pipeline by using
the early-load method

| | Cycle | | | | | | | | |
|---|---|---|---|---|---|---|---|---|---|
| Instruction | 1 | 2 | 3 | 4 | 5 | 6 | 7 | 8 | 9 |

| | | | | | | | |
|---|---|---|---|---|---|---|---|
| CMP r1, #10 | IF | ID | EXE | MEM | WB | | |
| BEQ loop | IF | ID | EXE | MEM | WB | | |
| LOAD r2, [r0 | | IF | ID(EL) | EXE | MEM | WB | |
| #0] | | | | | | | |
| ADD r3, r3, | | IF | ID | EXE | MEM | WB | |
| r2 | | | | | | | |
| ADD r1, r1, | | | IF | ID | EXE | MEM | WB |
| #1 | | | | | | | |

TABLE 4
Process timing table of each instruction in the pipeline without
using the early-load method

| | Cycle | | | | | | | | |
|---|---|---|---|---|---|---|---|---|---|
| Instruction | 1 | 2 | 3 | 4 | 5 | 6 | 7 | 8 | 9 |
| CMP r1, #10 | IF | ID | EXE | MEM | WB | | | | |
| BEQ loop | IF | ID | EXE | MEM | WB | | | | |
| LOAD r2, | | IF | ID | EXE | MEM | WB | | | |
| [r0 #0] | | | | | | | | | |
| ADD r3, r3, | | IF | ID | stall | stall | EXE | MEM | WB | |
| r2 | | | | | | | | | |
| ADD r1, r1, | | | IF | stall | stall | ID | EXE | MEM | WB |
| #1 | | | | | | | | | |

As shown in table 4, because the instruction “LOAD r2, [r0 #0]” needs to be fetched from the data cache into the register r2, the next instructions “ADD r3, r3, r2” and “ADD r1, r1, #1” are delayed several cycles (marked as stall in table 4) until the data fetching operation of the instruction “LOAD r2, [r0 #0]” is completed (marked as MEM in table 4). As shown in table 3, since the early-load method described in foregoing embodiment is adopted, the instruction “LOAD r2, [r0 #0]” already fetches its early-loaded data from the data cache into the ELQ 360 through the early-load unit 370 during the instruction decoding phase ID, so that the instruction data fetching operation MEM needs not to fetch data from the data cache again. Accordingly, the following instruction “ADD r3, r3, r2” does not have to wait and the instruction executing operation EXE is carried out right after the instruction decoding operation ID is completed. In the embodiment described above, the early-loaded data corresponding to an instruction is early-loaded when the instruction waits in the instruction queue. Accordingly, the delay between data loading and data processing in the design of pipeline processor can be avoided. The deeper the depth (level) of the pipeline is, the better the performance of the early-load method will get.

In order to determine whether the early-loaded data corresponding to the instruction is correctly loaded into the ELQ 360, the processor in the present embodiment executes an invalidation mechanism to check whether the data is correctly loaded. If the instruction decode stage 330 decodes a second instruction (any instruction), the state of a destination register appointed by the second instruction in the register status table 380 is set to busy. For example, the destination register appointed by the second instruction is R2, and accordingly the state field State[1:0] in the register status table 380 corresponding to the register R2 is set to “11” (representing the busy state) so that other instructions will not access the register R2. After that, the processor searches all the entries in the ELQ 360. If an entry (another instruction different from the second instruction) in the ELQ 360 points to the destination register (for example, the register R2) appointed by the second instruction, the processor sets the state field State[1:0] (referring to table 1) of the entry/instruction in the ELQ 360 to “00” (representing the invalid state). Thus, the problem of data dependency can be avoided.

Additionally, if a second instruction (any instruction) in the instruction execution stage 340 writes data into a particular address in the data cache or the memory, the processor searches the ELQ 360. If the searching result shows that an entry/instruction in the ELQ 360 is the same as the memory address to be written by the second instruction, the processor sets the state field State[1:0] of the entry/instruction in the ELQ 360 to “00” (representing the invalid state). Thus, the problem of memory dependency can be avoided.

In overview, the mechanism adopted in the present embodiment can be divided into two parts: early load policy and invalidation policy. The early load policy is to move data from the cache memory into the ELQ 360 in advance. The operations of the early load policy include:
1. pre-decoding the instruction before placing the instruction into the instruction queue 320, if the early load condition is met (for example, the instruction is a LDR or a LDRB instruction and the addressing mode thereof is immediate (pre(post)-indexed) offset) and the state of the base register thereof in the register status table 380 is ready, placing the instruction into the ELQ 360, and then loading the data from the cache or the memory into the ELQ 360 through the early-load unit 370.
2. checking whether the data in the ELQ 360 is ready and valid when the instruction enters the instruction decode stage 330, if the data in the ELQ 360 is ready and valid, renaming the destination register of the instruction to the corresponding entry or address in the ELQ 360.

Two errors may be produced by allowing a loaded instruction to fetch data from the cache or memory in the instruction fetch stage 310. One of the errors is data dependency and the other one is memory dependency. Data dependency takes place when another instruction calculates the value of the base register and accordingly the instruction which performs “early load” may obtain the old value of the base register and access the memory according to the old value. In this case, wrong data is fetched from the wrong address. Memory dependency takes place when the instruction which performs “early load” accesses the same memory address as another storing instruction, so that the data fetched by the instruction which performs “early load” may not be updated. The invalidation policy is used for checking whether the loaded data is correct. In the invalidation policy, the occurrence of these two cases is checked. If these problems occur, the corresponding entry/instruction in the ELQ 360 is set to invalid in advance. Correct data is fetched from the cache or the memory when the instruction execution stage 340 executes the instruction. The operations of the invalidation policy include:
Case 1: checking whether the base register is valid:
   when any instruction passes through the instruction decode stage 330, setting the state field of the destination register thereof in the register status table 380 to busy, searching the ELQ 360 to determine whether there is any instruction uses this base register, and if there is an instruction in the ELQ 360 uses the base register, setting the state field of the corresponding entry in the ELQ 360 to invalid.
Case 2: checking whether the memory address is valid:
   when a storing instruction generates a memory address in the instruction execution stage 340, searching the ELQ 360 to determine whether there is the same memory address in the ELQ 360, and if there is the same memory address in the ELQ 360, setting the state field of the corresponding entry in the ELQ 360 to invalid.

In overview, an early load mechanism is adopted in the present embodiment, wherein data is early-loaded from the cache or memory into an ELQ in the processor when the instruction waits to be executed in the instruction queue, and an invalidation policy is provided to check whether the fetched data is correct. Thereby, if the pipeline 300 successfully early-loads the data into the ELQ, the delay between data loading and data processing can be reduced effectively, and even when the pipeline 300 cannot early-load the data into the ELQ successfully, the performance of the processor is not affected.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An early-load method of a processor, comprising:
fetching and determining an instruction in an instruction fetch stage to obtain a determination result;
determining whether to early-load an early-loaded data corresponding to the instruction according to the determination result; and
serving the early-loaded data as a target data of the instruction if the early-loaded data is loaded correctly.

2. The early-load method according to claim 1, further comprising:
determining whether to place the instruction into an early-load queue (ELQ) according to the determination result;
executing the instruction to load the early-loaded data corresponding to the instruction before an instruction execution stage; and
placing the early-loaded data into the ELQ.

3. The early-load method according to claim 2, wherein the ELQ comprises a state field, a program counter field, a register information field, a memory address field, and an early-loaded data field.

4. The early-load method according to claim 3, further comprising:
decoding the instruction in an instruction decode stage to obtain a decoding result; and
checking a register status table according to the decoding result to determine whether the early-loaded data is correctly loaded into the ELQ.

5. The early-load method according to claim 4, wherein the register status table comprises a state field and an ELQ address field.

6. The early-load method according to claim 4, further comprising:
setting the state of a destination register appointed by a second instruction in the register status table to busy if the second instruction is decoded in the instruction decode stage;
searching all the entries in the ELQ; and
setting an entry in the ELQ as invalid if the entry points to the destination register appointed by the second instruction.

7. The early-load method according to claim 4, further comprising:
searching the ELQ if the second instruction writes data into a memory address in the instruction execution stage; and
setting an entry in the ELQ as invalid if the entry is the same as the memory address.

8. The early-load method according to claim 1, wherein the step of determining whether to early-load the early-loaded data corresponding to the instruction comprises:
checking a register status table; and
loading the early-loaded data corresponding to the instruction into an ELQ if the determination result shows that the instruction belongs to a target type and the state of a register corresponding to the instruction in the register status table is ready.

9. The early-load method according to claim 1, wherein the step of serving the early-loaded data as the target data comprises:
checking whether data in the ELQ is ready and valid in the instruction decode stage; and
changing the address of a destination register appointed by the instruction to the address of the early-loaded data in the ELQ if the data in the ELQ is ready and valid.

10. The early-load method according to claim 1, further comprising:
fetching the target data according to the instruction in the instruction execution stage if the early-loaded data is not loaded correctly.

11. A processor, comprising:
an instruction fetch stage, for fetching an instruction, wherein the instruction fetch stage comprises a pre-decoding unit for pre-determining the instruction in the instruction fetch stage and obtaining a determination result;
an instruction decode stage, coupled to the instruction fetch stage for decoding the instruction and obtaining a decoding result;
an instruction execution stage, coupled to the instruction decode stage for executing the instruction according to the decoding result; and
an ELQ, coupled to the pre-decoding unit for determining whether to early-load an early-loaded data corresponding to the instruction according to the determination result, wherein the instruction execution stage fetches a target data according to the instruction if the early-loaded data is not correctly loaded, and the early-loaded data is served as the target data if the early-loaded data is correctly loaded.

12. The processor according to claim 11, wherein the ELQ comprises a state field, a program counter field, a register information field, a memory address field, and an early-loaded data field.

13. The processor according to claim 11, wherein the ELQ determines whether to record the instruction according to the determination result.

14. The processor according to claim 11, further comprising:
an early-load unit, coupled to the ELQ for executing the instruction to place the early-loaded data corresponding to the instruction into the ELQ before the instruction enters the instruction execution stage.

15. The processor according to claim 14, further comprising:
a register status table, coupled to the instruction decode stage for recording the states of a plurality of registers in the processor;
wherein the instruction decode stage decodes the instruction and checks the register status table according to the decoding result to determine whether the early-loaded data is correctly loaded into the ELQ.

16. The processor according to claim 15, wherein the register status table comprises a state field and an ELQ address field.

17. The processor according to claim 15, wherein if the instruction decode stage decodes a second instruction, the state of a destination register appointed by the second instruction in the register status table is set to busy, the processor searches all the entries in the ELQ, and if an entry in the ELQ points to the destination register appointed by the second instruction, the processor sets the entry as invalid.

18. The processor according to claim 15, wherein the processor searches the ELQ if a second instruction writes data into a memory address in the instruction execution stage, and the processor sets an entry in the ELQ as invalid if the entry is the same as the memory address.

19. The processor according to claim 14, wherein the early-load unit shares hardware with a loading/storage unit in the instruction execution stage.

20. The processor according to claim 11, further comprising:
a register status table, coupled to the instruction decode stage for recording the states of a plurality of registers in the processor;
wherein the early-loaded data corresponding to the instruction is loaded into the ELQ if the determination result shows that the instruction belongs to a target type and the state of a register corresponding to the instruction in the register status table is ready.

21. The processor according to claim 11, wherein the instruction decode stage checks whether data in the ELQ is ready and valid, and if the data in the ELQ is ready and valid, the address of the destination register appointed by the instruction is changed to the address of the early-loaded data in the ELQ.
